(19) United States
(12) Patent Application Publication
(10) Pub. No.: US 2025/0031603 A1
(43) Pub. Date: Jan. 30, 2025

(54) SEED SPIKE AND PLANTER USING SAME

(71) Applicant: Reenvision Ag, Inc., Nora Springs, IA (US)

(72) Inventors: Jayson Ryner, Nora Springs, IA (US); Zachary Kooistra, Cedar Falls, IA (US); Nials Dybro, Nora Springs, IA (US)

(21) Appl. No.: 18/787,564

(22) Filed: Jul. 29, 2024

Related U.S. Application Data
(60) Provisional application No. 63/516,287, filed on Jul. 28, 2023.

(51) Int. Cl. A01C 7/00

(52) U.S. Cl. CPC A01C 7/002

(57) ABSTRACT

Disclosed is a seed spike assembly may include a body having an inclined back side and a front side that connect to form a substantially pointed end.

### CROSS REFERENCE TO RELATED APPLICATIONS

This application claims the benefit of U.S. Provisional Patent Application No. 63/516,287 which was filed with the United States Patent and Trademark Office on Jul. 28, 2023, the entire contents of which is herein incorporated by reference.

### BACKGROUND

### 1. Field

Example embodiments relate to a seed spike assembly and a planter using the same.

### 2. Description of the Related Art

Seed dibblers were devised centuries ago to aid in the planting of seeds. Ancient seed dibblers were as simple as a sharp stick carried by a worker; the worker simply stabbed the sharp end into the ground to a desired depth, then dropped in a seed in the indentation, and thereafter covered the seed with dirt. However, the inefficiencies of planting large fields by hand using seed dibblers is impractical. Instead, modern farming techniques generally use a tractor to move a planter which includes an opener to open the ground, a mechanism to drop seed into the opened ground, and a closer to cover the seed with soil. While such planters have greatly improved crop yields they are not without their problems. For example, modern tillage practices often result in poor soil health, damage to organic matter, excessive erosion, and soil compaction. Additionally, fuel, labor, and equipment associated with tilling soil also adds significant cost to farming operations.

### SUMMARY

The inventor set out to develop a planting technique which does not include the problems associated with modern tilling operations. As a result, the inventor developed a seed spike assembly configured to plant a seed in soil with minimal soil disruption. The seed spike assembly generally includes a body having a pointed end which can be inserted into the ground.

### BRIEF DESCRIPTION OF THE DRAWINGS

Example embodiments are described in detail below with reference to the attached drawing figures, wherein:

FIG. 1 is a first perspective view of a seed spike assembly in accordance with a nonlimiting example of the invention;

FIG. 2 is a second perspective view of the seed spike assembly in accordance with a nonlimiting example of the invention;

FIG. 3 is a section view of the seed spike assembly in accordance with a nonlimiting example of the invention;

FIG. 4 is a view of structures to actuate ejection and blocking pins of the seed spike assembly;

FIG. 5 is a cross-section view of a seed spike assembly in a home configuration in accordance with a nonlimiting example of the invention;

FIG. 6 is a cross-section view of the exemplary seed spike assembly with a blocking pin retracted to allow a seed to exit the exemplary seed spike;

FIG. 7 is a cross-section view of the exemplary seed spike assembly with an ejection pin actuated to press the seed into the soil;

FIG. 8 is a cross-section view of the exemplary seed spike assembly back in the home configuration;

FIG. 9 is a view of the exemplary seed spike assembly;

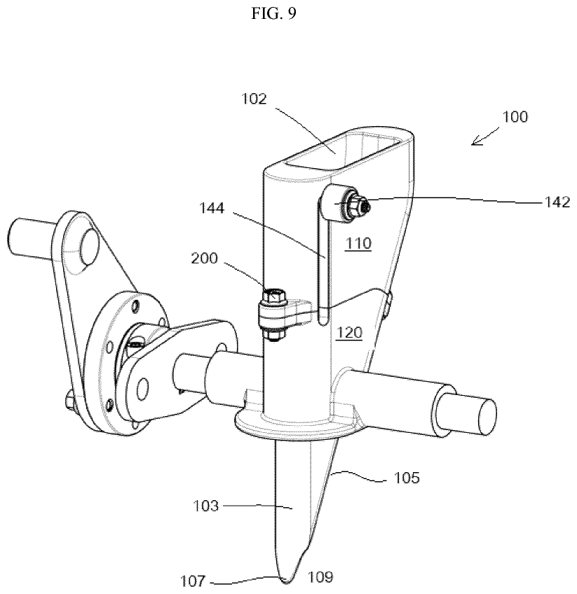

FIG. 10 is another view of the exemplary seed spike assembly; and

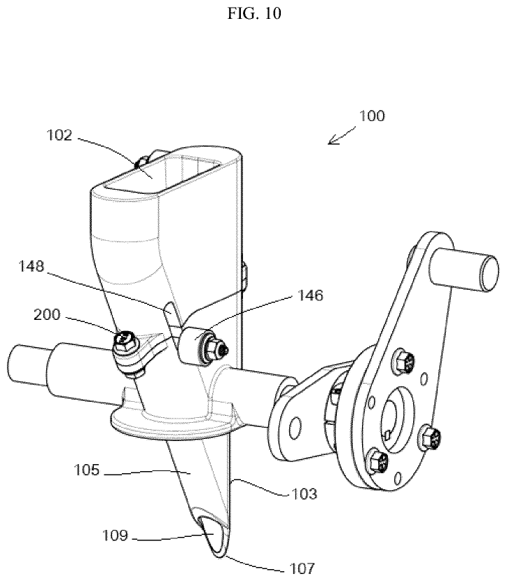

FIG. 11 is a view of a body in accordance with an exemplary seed spike assembly.

### DETAILED DESCRIPTION

Example embodiments will now be described more fully with reference to the accompanying drawings. Example embodiments are not intended to limit the disclosure since the disclosure may be embodied in different forms. Rather, example embodiments are provided so that this disclosure will be thorough and complete, and will fully convey the scope of the disclosure to those skilled in the art. In the drawings, the sizes of components may be exaggerated for clarity.

In this application, when a first element is described as being “on” or “connected to” a second element, the first element may be directly on or directly connected to the second element or may be on or connected to an intervening element that may be present between the first element and the second element. When a first element is described as being “directly on” or “directly connected to” a second element, there are no intervening elements. In this application, the term “and/or” includes any and all combinations of one or more of the associated listed items.

In this application, spatially relative terms merely describe one element's relationship to another. The spatially relative terms are intended to encompass different orientations of the structure. For example, if a first element of a structure is described as being “above” a second element, the term “above” is not meant to limit the disclosure since, if the structure is turned over, the first element would be “beneath” the second element. As such, use of the term “above” is intended to encompass the terms “above” and “below”. The structure may be otherwise oriented (rotated 90 degrees or at other orientations) and the spatially relative descriptors used herein interpreted accordingly.

Example embodiments are illustrated by way of ideal schematic views. However, example embodiments are not intended to be limited by the ideal schematic views since example embodiments may be modified in accordance with manufacturing technologies and/or tolerances.

The subject matter of example embodiments, as disclosed herein, is described with specificity to meet statutory requirements. However, the description itself is not intended to limit the scope of this patent. Rather, the inventors have contemplated that the claimed subject matter might also be embodied in other ways, to include different features or combinations of features similar to the ones described in this document, in conjunction with other technologies. Example embodiments relate to a seed spike and a planter using the same.

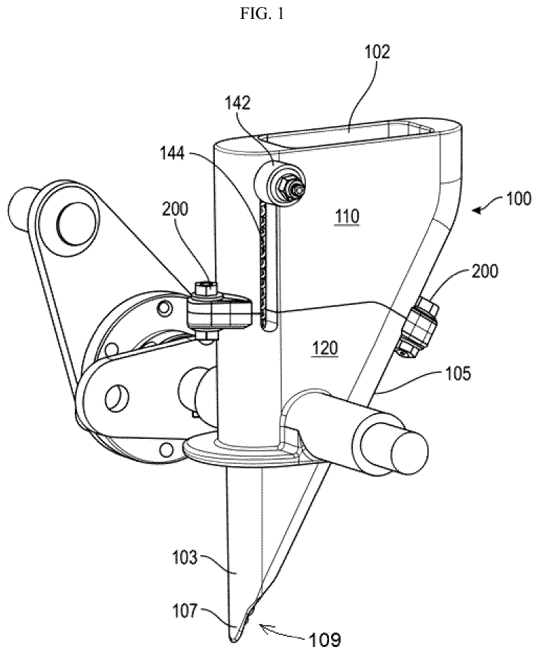

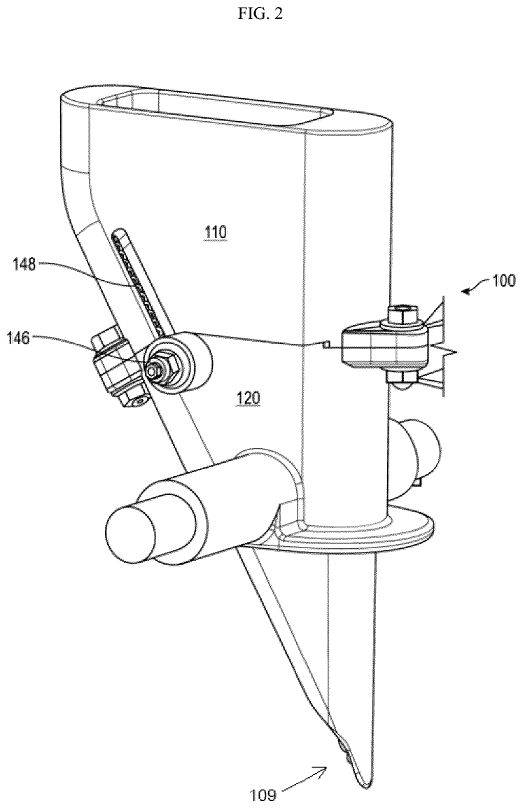

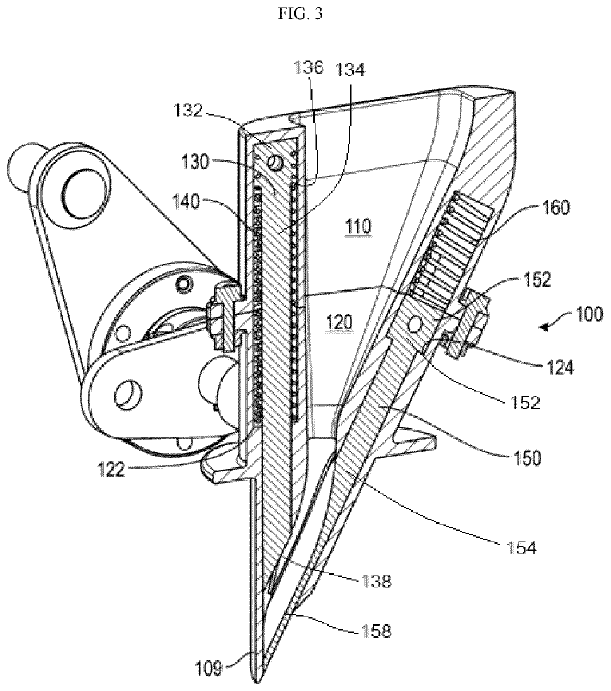

FIG. 1 is a first perspective view of a seed spike assembly 100 in accordance with an example of the invention. FIG. 2 is a second perspective view of the exemplary seed spike assembly 100. FIG. 3 is a section view of the exemplary seed spike assembly 100. As shown in FIGS. 1-3 the seed spike assembly 100 may be comprised of an upper chamber 110 and a lower chamber 120. Each of the upper chamber 110 and the lower chamber 120 may be connected to one another via conventional fasteners 200, for example, screws, pins, bolts, clips, adhesives, and/or weld material. In example embodiments, the upper and lower chambers 110 and 120 may be hollow to receive a seed for insertion into the ground. In one nonlimiting example embodiment, the upper chamber 110 of the spike 100 may connect to a seed funnel (not shown) which receives feed from a seed meter. This embodiment, however, is mentioned only for purpose of illustration and not limitation.

As shown in FIG. 1, the exemplary seed spike assembly 100 has a first side 103 which may be substantially vertical and a second side 105 which is inclined. As such, when the first side 103 and second side 105 come together, they form a somewhat pointed end 107 which facilitates insertion of the seed spike assembly 100 into the ground.

In example embodiments, the seed spike assembly 100 may include an ejection pin 130 biased into a home position (as shown in FIG. 3) by a biasing member 140. The ejection pin may include a head 132 which, in one embodiment, may resemble a short cylinder, and a body 134, which in one embodiment, may resemble a cylinder having a diameter smaller than that of the head 132 and an inclined end 138. At the change of diameter between the head 132 and the body 134 is a surface 136 upon which the biasing member 140 may press. The biasing member 140 may take on several forms including, but not limited to, a coil spring. One end of the biasing member 140 may rest on a shelf 122 formed in the lower chamber 120 and another end of the biasing member 140 may press against surface 136. The head 132 of the ejection pin 130 may be attached to a roller 142 which may move up and down along a slot 144 formed in the seed spike assembly 100. The slot 144 may extend along the upper chamber 110 and into the lower chamber 120 as shown in FIG. 1, but this is for purpose of illustration only. As one skilled will readily appreciate, moving the roller 142 along the slot 144 displaces the ejection pin 130 (for example, moves it vertically).

In example embodiments, the seed spike 100 may also include a blocking pin 150 biased into a home position (as shown in FIG. 3) by a biasing member 160. The blocking pin 150 may include a head 152 which, in one embodiment, may resemble a short cylinder, and a body 154, which in one embodiment, may resemble a cylinder having a diameter smaller than that of the head 152 and an inclined end 158. The biasing member 160 may take on several forms including, but not limited to, a coil spring. The head 152 end 152 of the blocking pin 150 may rest on or press against a shelf 124 formed in the lower chamber 120 when in a home position as shown in at least FIG. 3. The head 152 of the blocking pin 150 may be connected to a roller 146 which may move along a slot 148 formed in the seed spike assembly 100. As the roller 146 moves along the slot 148 the blocking pin 150 is moved and into the biasing member 160. The biasing member 160 tends to bias the blocking pin 150 back to its home position as shown in FIG. 3.

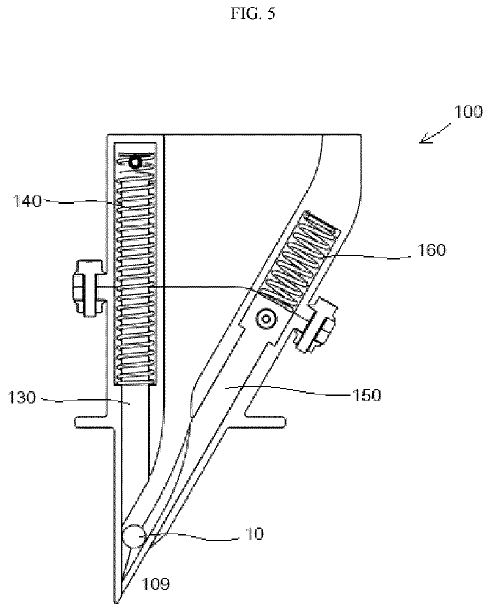

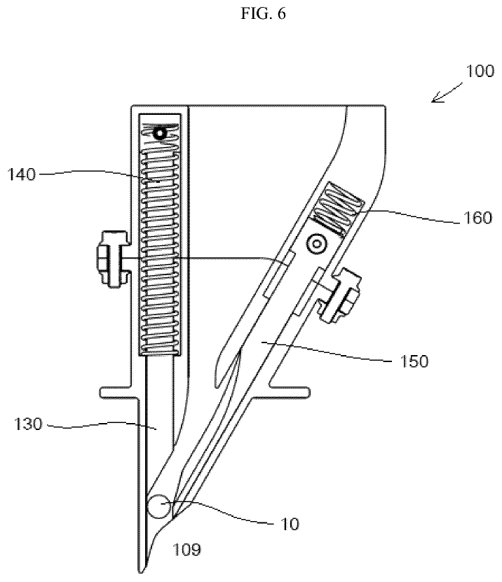

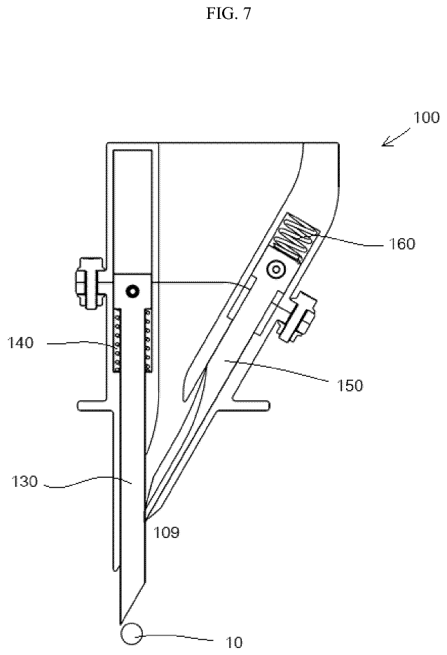

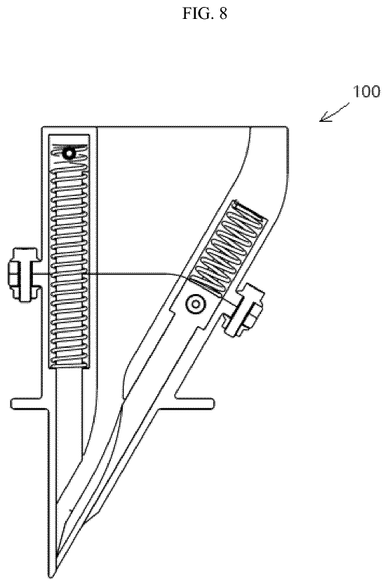

In example embodiments the seed spike assembly 100 may receive a seed via an opening 102 in the seed spike 100. The seed falls into the seed spike 100 and towards an exit hole 109 arranged near a bottom of the seed spike 100. The seed, however, may be prevented from exiting the seed spike assembly 100 when the blocking pin 150 is in its home position. However, when the blocking pin 150 is moved out of it's home position by the roller 146 the exit hole 109 is exposed allowing the seed to exit the spike 100. When this happens the ejection pin 130 may move downwards to contact the seed and press the seed into the soil to improve seed soil contact. FIGS. 5-8 illustrate a cross-section view of the seed spike assembly 100 when used to plant a seed 10 into the ground. As shown in FIG. 5, a seed 10 may be received by the seed spike assembly 100 through the opening 102 of the seed spike 100 and travel near the exit hole 109. The seed 10, however, is blocked from passing through the exit hole 109 by the blocking pin 150. FIG. 6, shows the blocking pin 150 displaced from its home position (see FIG. 5). This may occur when roller 146 contacts a cam surface of an assembly to which the seed spike assembly 100 is attached. When the blocking pin 150 is moved upwards the exit hole 109 of the seed spike assembly 100 is exposed allowing the seed 10 to pass out of the seed spike assembly 100 via the exit hole 109. The cam surfaces of the larger assembly may be configured so that as the seed 10 passes through the exit hole 109 the ejection pin 130 is moved downwards under the influence of the first roller 142 when the first roller 142 engages a cam surface of the larger assembly. This ejection pin 130 presses the seed into the ground to increase soil seed contact. In addition, any debris which may have been trapped in the exit hole 109 is removed by the ejection pin 130 as an end of the ejection pin 130 passes through the exit hole 109. After the seed 10 has been planted, the rollers 142 and 146 may disengage their respective cam surfaces allowing the ejection pin 130 and blocking pin 150 to return to their respective home positions under the influence of the biasing members 140 and 160.

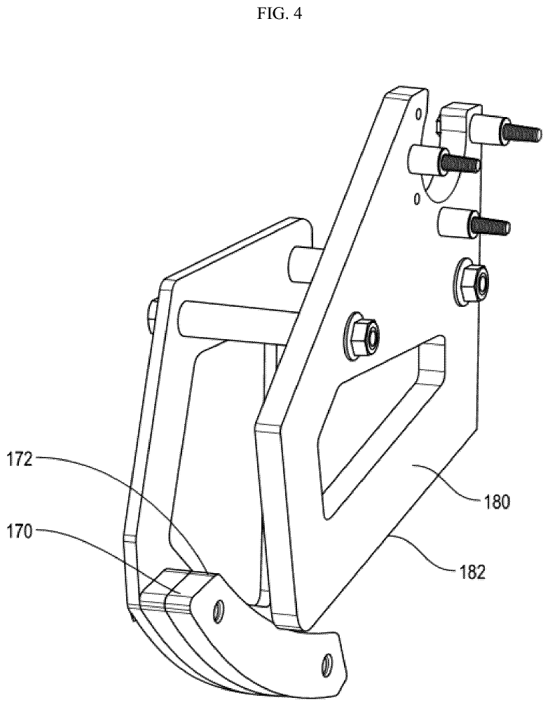

In example embodiments the seed spike assembly 100 may be part of a larger mechanism which may facilitate usability of the seed spike assembly 100. For example, the mechanism may have a wheel and one or more seed spikes 100 may be arranged at the circumference of the wheel. As the wheel rotates the ends 107 of the seed spike 100 are pushed into the ground and the rollers 142 and 146 may be brought into contact with structural elements (e.g. cam surfaces) which cause the rollers 142 and 146 to move along the slots 144 and 148. For example, FIG. 4 illustrates example structures 170 and 180 which the rollers 142 and 146 may be brought into contact with to actuate the rollers 142 and 146. In this nonlimiting example embodiments the seed spike assembly 100 may be rotated between the structures 170 and 180. More specifically, as the spike 100 rotates between the structures 170 and 180 the roller 146 of the blocking pin 150 engages an upper surface 172 of a ledge of structure 170 before the roller 142 of the ejection pin 130 engages a lower surface 182 of structure 180. This causes the blocking pin 150 to move upwards relative to a body of the spike assembly 100 thus exposing the exit hole 109 of the spike 100 while the ejection pin 130 stays in place. Exposing the exit hole 109 allows the seed to exit the seed spike assembly 100. About this time the roller 142 of the ejection pin 130 engages a lower surface 182 of the second structure 180 causing the ejection pin 130 to move downwards to make contact with the seed and gently press the seed into the soil to enhance seed soil contact. When the rollers 142 and 146 cease contact with the structures 170 and 180 the biasing members 140 and 160 return the ejection pin 130 and the blocking pin 150 to their home positions shown in at least FIG. 3. It is noted returning the blocking pin 150 to its home position has been shown to clear the exit hole 109 of any debris.

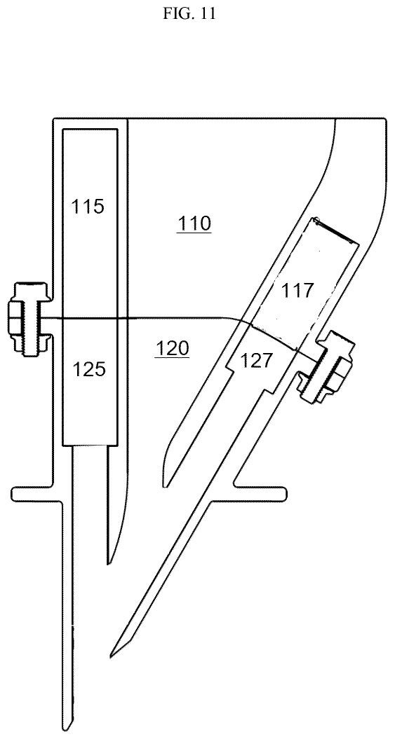

It is understood the aforementioned is not meant to limit the invention but to illustrate certain inventive concepts. For example, in example embodiments, the exemplary seed spike assembly 100 is illustrated as having a body comprised of an upper chamber 110 connected to a lower chamber 120 by fasteners 200. The upper chamber 110 may have a first channel 115 which aligns with first channel 125 of the lower chamber 120 to form a first continuous channel through which the ejection pin 130 may traverse (see FIG. 11). The upper chamber 110 may also include a second channel 117 which may align with a second channel 127 of the lower chamber 120 to form a second continuous channel through which the blocking pin 150 may traverse. As one skilled in the art would readily appreciate, the continuous channels laterally restrain the ejection pin 130 and the blocking pin 150 while allowing motion along their axis. Further, these continuous channels are inclined from one another. However, these inventive concepts may be embodied differently. For example, rather than having an upper chamber 110 and a lower chamber 120 the body of the seed spike assembly 100 may resemble more of a clam-shell type of configuration wherein the clam-shell embodiment has channels to laterally restrain the ejection and blocking pins similar to that described above. In other words, the disclosed embodiments are clearly not intended to limit the invention but to merely show how the inventive concepts may be enabled. Further, certain elements disclosed herein are not strictly required. For example, while rollers have been found to be particularly useful in actuating the blocking and ejection pins, another structure, for example, tabs and/or plates may be used instead of rollers.

What is claimed:

1. A seed spike assembly comprising:
a body having a first channel and a second channel inclined from the first channel;
an ejection pin in the first channel biased by a first biasing member; and
a blocking pin in the second channel biased by a second biasing member, wherein the blocking member is configured to block an exit of the body and expose the exit of the body.

2. The seed spike assembly of claim 1, wherein an end of the ejection pin is configured to protrude out of the body.

3. The seed spike assembly of claim 1, wherein the body is substantially hollow to receive a seed.

4. The seed spike assembly of claim 1, wherein the ejection pin includes a head and a body, wherein the head has a larger diameter than the body.

5. The seed spike assembly of claim 1, further comprising a first roller connected to the ejection pin and a second roller connected to the blocking pin.

6. The seed spike assembly of claim 5, wherein the body includes a first slot along with the first roller traverses and a second slot along which the second roller traverses.

7. A method of planting a seed comprising:
inserting an end of the seed spike assembly of claim 1 into the ground;
actuating the blocking pin to expose the exit of the body to allow a seed to leave the body; and
actuating the ejection pin to press the seed into the ground and clear debris from the exit hole.

8. The method of claim 7, wherein the blocking pin is actuated before the ejection pin.

9. The method of claim 7, wherein the seed is received by the seed spike assembly before the blocking pin is actuated.

10. The method of claim 7, wherein the blocking pin is actuated by a roller connected to the blocking pin and the ejection pin is actuated by a roller connected to the ejection pin.
